(19) United States
(12) Patent Application Publication
(10) Pub. No.: US 2023/0305927 A1
(43) Pub. Date: Sep. 28, 2023

(54) REGISTER REPLAY STATE MACHINE

(71) Applicant: Intel Corporation, Santa Clara, CA (US)

(72) Inventors: Xueyan Wang, Lacey, WA (US); Vincent J. Zimmer, Issaquah, WA (US); Qing Yang Li, Shanghai (CN)

(73) Assignee: Intel Corporation, Santa Clara, CA (US)

(21) Appl. No.: 18/326,918

(22) Filed: May 31, 2023

(30) Foreign Application Priority Data
Apr. 27, 2023 (WO) PCT/CN2023/091377

(51) Int. Cl. G06F 11/14; G06F 11/07

(52) U.S. Cl. CPC G06F 11/1417; G06F 11/0721

(57) ABSTRACT

Register operations to cause a processor unit to enter into a management operating mode are stored in a dedicated buffer in the processor unit and are executed by the processor unit when the processor unit is to enter into a management operating mode. The register operations can be stored in the buffer during computing system startup or by out-of-band provisioning during computing system runtime. The register operations can save a state of the processor unit as part of entering the management operating mode and restore the state when the processor unit exits the management operation mode. In computing systems comprising multiple processor units, the register operations can cause one of the processor units to execute management operating mode instructions and one or more other processor units to enter into an idle mode while the processor units are in the management operating mode.

This application claims the benefit of priority under 35 U.S.C. § 119(e) to PCT International Application Serial No. PCT/CN2023/091377 filed on Apr. 27, 2023 and entitled “Register Replay State Machine”. The prior application is hereby incorporated by reference in its entirety.

### BACKGROUND

Some existing high-performance processors possess extensive reliability, availability, and serviceability (RAS) capabilities. RAS capabilities can include error detection, error correction, and error containment as well as failover and hot-addition/removal of computing resources. RAS failover and hot-add/remove operations often require the ability of a computing system to coordinate elements of the system and place them into a known state.

### BRIEF DESCRIPTION OF THE DRAWINGS

FIG. 1 illustrates an example flow of operations in an example computing system employing an SMM-based quiesce operation.

FIG. 2 illustrates an example flow of operations in a computing system employing an RRSM-based quiesce operation.

FIG. 3 illustrates an example method of creating an RRSM runtime handler and allocating an RRSM buffer.

FIG. 4 illustrates an example RRSM runtime handler method.

FIG. 5 is an example method of storing register operations to cause a processing unit to enter into a management operating mode and execute the register operations.

FIG. 6 is a block diagram of an example computing system within which the technologies described herein can be utilized.

FIG. 7 is a block diagram of an example processor unit to execute computer-executable instructions as part of implementing technologies described herein.

### DETAILED DESCRIPTION

The failover and hot-add/remove operations of a computing system's reliability, availability, and serviceability (RAS) capabilities often require the ability of the computing system to coordinate elements of the system and place them into a known state. This operation can be referred to as ‘quiesce’ and is often implemented via collaboration between the operating system, ACPI (Advanced Configuration and Power Management Interface), and management operating mode (e.g., SMM (System Management Mode) in computing systems employing Intel® processors) flows. One challenge with existing quiesce operation implementations is that deploying management operating mode instructions (e.g., SMM code) is becoming increasingly difficult given the performance overhead of deploying such quiesce operation instructions to all processing units in a computing system. For example, in some SoC (System-on-a-Chip) implementations, quiesce operation instructions may need to be deployed to hundreds of cores. An additional challenge is that new threat models may treat management operating mode code as untrusted.

Some existing quiesce operation implementations involve tight coupling between hardware and host firmware flows, such as those utilizing SMM. These solutions entail the host firmware initializing data structures during the boot process and flows that are acted upon during runtime by a host firmware system management mode (e.g., SMM). These solutions can have the disadvantage of a long quiesce operation flow, which requires time to rendezvous all processing units (that is, retrieve management operating mode register operations, save the states of the processing units, and place the processor units into a known state), enter a management operating mode, and run management operating mode instructions. In addition to this availability impact, existing management operating mode flows are subject to various attacks.

The technologies disclosed herein implement a “register replay” state machine (RRSM) that executes a set of register operations stored in an RRSM buffer when a processor unit enters a management operating mode. In some embodiments, an RRSM can be implemented in firmware, hardware, or a combination thereof. The register operations can include I/O (input/output), memory, and memory-mapped I/O (MMIO) read, write, and read-modify-write operations. One advantage of register replay state machines is that they can offload dependencies on ecosystem-provided host firmware and management operating mode flows (e.g., SMM for AMD and Intel® processors, TrustZone® for ARM® processors, and Machine Mode for RISC-V® processors) that can impact the availability of computing systems and as noted above, increase the attack surface of a computer system, and lack scalability.

In the following description, specific details are set forth, but embodiments of the technologies described herein may be practiced without these specific details. Well-known circuits, structures, and techniques have not been shown in detail to avoid obscuring an understanding of this description. Phrases such as “an embodiment,” “various embodiments,” “some embodiments,” and the like may include features, structures, or characteristics, but not every embodiment necessarily includes the particular features, structures, or characteristics.

Some embodiments may have some, all, or none of the features described for other embodiments. “First,” “second,” “third,” and the like describe a common object and indicate different instances of like objects being referred to. Such adjectives do not imply objects so described must be in a given sequence, either temporally or spatially, in ranking, or any other manner. Furthermore, the terms “comprising,” “including,” “having,” and the like, as used with respect to embodiments of the present disclosure, are synonymous.

In the following description, for purposes of explanation, specific details are set forth to provide a thorough understanding thereof. It may be evident, however, that the novel embodiments can be practiced without these specific details. In other instances, well known structures and devices are shown in block diagram form to facilitate a description thereof. The intention is to cover all modifications, equivalents, and alternatives within the scope of the claims

As used herein, the term “integrated circuit component” refers to a packaged or unpacked integrated circuit product. A packaged integrated circuit component comprises one or more integrated circuit dies mounted on a package substrate with the integrated circuit dies and package substrate encapsulated in a casing material, such as a metal, plastic, glass, or ceramic. In one example, a packaged integrated circuit component contains one or more processor units mounted on a substrate with an exterior surface of the substrate comprising a solder ball grid array (BGA). In one example of an unpackaged integrated circuit component, a single monolithic integrated circuit die comprises solder bumps attached to contacts on the die. The solder bumps allow the die to be directly attached to a printed circuit board. An integrated circuit component can comprise one or more of any computing system component described or referenced herein or any other computing system component, such as a processor unit (e.g., system-on-a-chip (SoC), processor core, graphics processor unit (GPU), accelerator, chipset processor), I/O controller, memory, or network interface controller.

Reference is now made to the drawings, which are not necessarily drawn to scale, wherein similar or same numbers may be used to designate same or similar parts in different figures. The use of similar or same numbers in different figures does not mean all figures including similar or same numbers constitute a single or same embodiment. Like numerals having different letter suffixes may represent different instances of similar components. The drawings illustrate generally, by way of example, but not by way of limitation, various embodiments discussed in the present document.

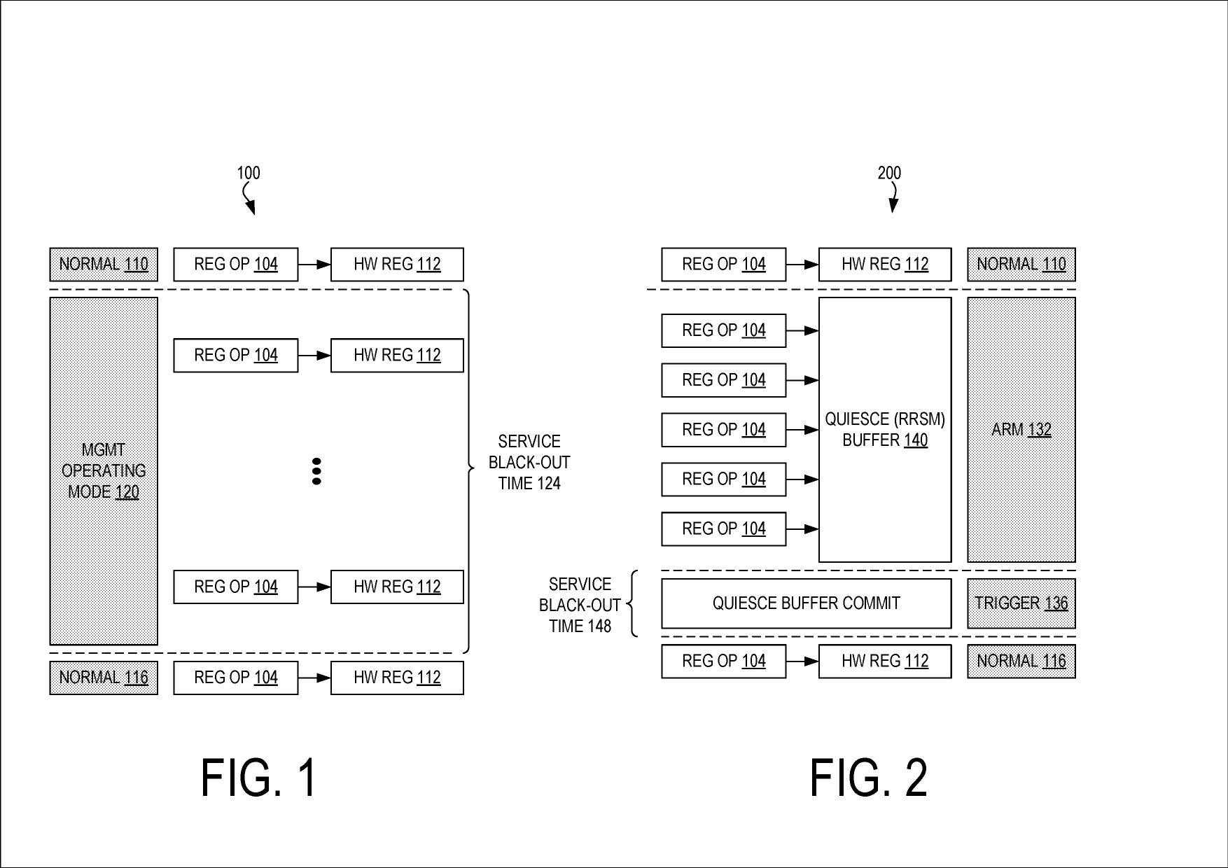

FIG. 1 illustrates an example flow of operations in an example computing system employing an SMM-based quiesce operation. The operations 100 comprise individual register operations 104 that are performed by processing units of a computing system. Each register operation acts on one or more hardware registers 112. The register operations 104 can comprise I/O (input/output), memory, and memory-mapped I/O (MMIO) read, write, and read-modify-write operations. A hardware register 112 can be a register of an integrated circuit component (e.g., CPU or any other processor unit) or any other hardware component of the computing system. Further, a hardware register can be a dedicated memory element or part of a larger memory (e.g., a buffer, a location in cache or system memory). The operations 100 comprise register operations that can be performed by multiple processor units in a computing system. The operations 100 comprise a first set of operations 110 performed by a processor unit while the processor unit is in a “normal” operating mode, with “normal” indicating that the operations 110 are executed while a processor unit is in an operating mode that has a privilege level below that of a management operating mode. For example, in Intel® processors, in which the SMM mode can be considered to operate a privilege (or ring) level of −2 (the lower the privilege level number, the higher the privilege level), the operations 110 can occur while the processor unit is operating at a privilege (or ring) level of 0 through 3. The operations 110 could thus be part of, for example, an operating system kernel (ring 0), device drivers (rings 1 or 2), or an application program (ring 3).

As used herein, the term “management operating mode” refers to a protected mode of a processing unit that provides a separate execution environment for the performance of system management functions and firmware-level operations. While in a management operating mode, a processing unit can handle system-wide events, such as power management, system monitoring, and certain types of system interrupts. Example management operating modes include System Management Mode (SMM) for AMD and Intel® processors, TrustZone® for ARM® processors, and Machine Mode for RISC-V® processors.

The operations 100 further comprise a set of management operating register operations 120 that rendezvous the processor units of a computing system (which, as noted above, can involve rendezvousing hundreds of cores in an SoC design). That is, the operations 120 execute a quiesce operation that comprises saving the states of the processor units and placing the processor units in a known state, such as an idle state. The operations 120 can be executed by one or more processor units in a computing system in response to the one or more processor units being caused to enter a management operating mode. In some embodiments, a processor unit can be caused to enter a management operating mode by a processor unit receiving information indicating that the processor unit is to enter a management operating mode, such as an interrupt or an instruction indicating that the processor unit is to enter a management operating mode.

The operations 120 can further cause management operating mode instructions to be executed that carry out management operating mode tasks, such as error handling and power management. These tasks can be performed after the quiesce operation has been completed. In some embodiments, while the processor units of a computing system are in a management operating mode, one processor unit executes the management operating mode instructions while the other processor units are in a known state, such as an idle state. The management operating mode instructions that are executed while the processor units are in the management operating mode can be considered injected RTU (run time update) code and thus the management operating mode can comprise the execution of injected RTU code. In some embodiments, the management operating mode instructions can be stored in a dedicated portion of memory prior to processor units entering the management operating mode (such as during a startup sequence of a computing system), with execution of the management operating mode instructions comprising a processor unit being instructed to perform a set of instructions beginning at an address at which the first management operating mode instruction is stored. The operations 120 further comprise restoring the stored states of the processor units in response to completed execution of the management operating mode instructions.

While the operations 120 are being performed, the processor units are unable to execute any operating system (e.g., kernel, device driver) or application code, and the processor units can be considered to be in a service black-out state, with the time that it takes for the operations 120 to perform being a “service black-out time” 124. The service black-out time 124 includes the overhead it takes for the processor units to fetch the operations 120. It is during this service black-out time that the processing unit and/or computing system can be attacked by non-management operating mode agents (e.g., non-SMM agents).

The operations 100 further comprise a second set of “normal mode” operations 116 that occur after the processor unit has exited from the management operating mode. As the stored states of the processor unit of a computing system have been restored as part of the processor units exiting the management operating mode, the processor units continue operating from the states they were in before the processor units before the start of the quiesce operation.

FIG. 2 illustrates an example flow of operations in a computing system employing an RRSM-based quiesce operation. The operations 200 comprise individual register operations 104. The operations 200 comprise sets of “normal” sets of operating mode register operations 110 and 116 that occur while the processor unit is not in an “arm” or “trigger” state. The operations 110 and 116 can occur while the processor units of a computing system are operating at a privilege level that is below that of a management operating mode of the processor units, as described above.

The operations 200 further comprise a set of “arm” operations 132 and “trigger” operations 136. The “arm” operations 132 comprise operations that store a set of register operations 104 in a quiesce (or RRSM) buffer 140. The register operations 104 stored in the quiesce buffer 140 can perform the functions performed by the register operations 104 comprising the management operating mode register operations 120 in FIG. 1, such as storing a processor unit state, putting a processor unit in a known state, instructing a processor unit to execute management operating mode instructions beginning at a management operating mode instruction starting address, and restoring the states of the processor unit upon exiting the management operating mode. With the register operations 132 arming the quiesce buffer 140, the register operations 104 stored in the quiesce buffer 140 are executed (or “played back”, or committed) as the “trigger” register operations 136 when the processor unit enters a management operating mode.

The quiesce buffer 140 can be any type of memory or memory element, such as a set of registers, a memory, or a portion of cache memory (e.g., L1, L2, L3 cache) that may be located within a processor unit or colocated with a processor unit in an integrated circuit component but external to the processor unit. In some embodiments, the quiesce buffer can be a memory or memory element dedicated for use as a quiesce buffer. That is, the memory or memory element only stores management operating mode register operations, register operations to cause the processor unit to perform register operations relating to a management operating mode. The quiesce buffer 140 can further comprise supporting logic, such as logic that controls buffer read and write operations and implements other buffer-related operations.

In some embodiments, the quiesce buffer 140 stores a table with each table entry comprising an address and information indicating the type of register operation to be performed (e.g., read, write, read-modify-write). The information indicating the type of operation to be performed can be a tag. The tag can further indicate the size of the register operation. Table entries associated with register write operations can further comprise the data to be written. Table entries associated with read-modify-write operations can further comprise a mask that is to be applied to the data to be written or indicate an operation to be performed on the data stored at the address (e.g., XOR, ADD) with any additional operands specified directly (the table entry comprises the data) or indirectly (e.g., the table entry stores the address of an additional operand). In some embodiments, the register address in each table entry can be a flattened address (e.g., a flattened MMIO (memory-mapped I/O) or a flattened PCIe (Peripheral Component Interconnect Express) MMIO address), a PCIe address, CSR (control and status register) identifier or address, a BAR (base address register) identifier or address plus an offset from the address value stored in the BAR.

The register operations 132 can be written to the quiesce buffer 140 during a startup sequence (e.g., boot sequence) of a computing system and before the computing system runtime (when control of the computing system is turned over to the operating system for general computing system usage). For example, register operations can be written to the quiesce buffer 140 during an early trusted boot by the host BIOS (Basic Input/Output System) or via an out-of-band facing manageability agent such as a Baseboard Management Controller (BMC). Out-of-band provisioning (or updating) of the quiesce buffer can occur at any time, such as during computing system runtime. Thus, the quiesce buffer can be armed just once and the register operations stored therein can be executed (or replayed) repeatedly as a processor unit enters a management operating mode. Put another way, the register operations are already in the quiesce buffer when a processor unit is caused to be placed in a management operating mode.

The service black-out time 148 for a processor unit employing an RRSM-based quiesce operation includes the time for the processor unit to fetch an operation from the quiesce buffer 140, which can be quicker than having to retrieve a register operation from system memory (e.g., DRAM, flash memory) or a lower-level cache memory (e.g., L2, L3, LLC (last level cache)). Thus, as illustrated in FIGS. 1 and 2, the service black-out time 148 of a processor unit employing an RRSM-based quiesce operation can be less than the service black-out time 124 of a processor unit employing a quiesce operation in which the register operations are retrieved from system memory each time a processor unit enters a management operating mode.

Having a shorter service black-out window and a hardware-based execution agent (e.g., a quiesce buffer that is implemented as a register set or dedicated memory) can provide the advantages of increased processor unit availability and reduced scaling issues and malware-infection risk present in quiesce operation solutions based on management operating mode solutions based on processor units having to access register operations from system memory each time the processor unit enters a management operating mode. Further, the quiesce buffer and supporting logic can be implemented in hardware that a processor vendor can validate once and not be subject to modification after fabrication. This is in contrast to SMM-based and similar flows that can comprise lengthy BIOS routines that customers may modify and inadvertently inject programming flaws.

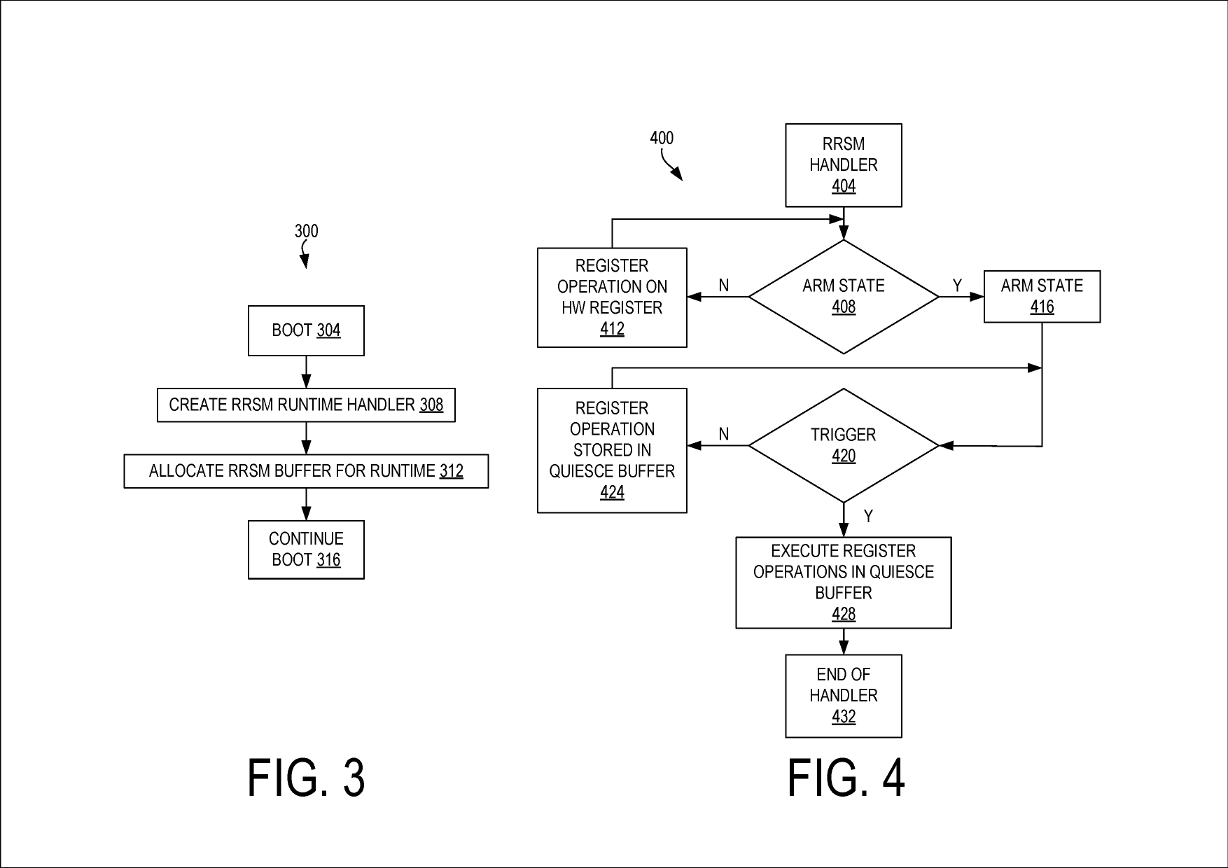

FIG. 3 illustrates an example method of creating an RRSM runtime handler and allocating an RRSM buffer. The method 300 begins at 304 at which point one or more operations of a computing system startup sequence have already been performed. At 308, the boot sequence creates an RRSM runtime handler. At 312, an RRSM buffer is allocated. After creation of the RRSM runtime handler and RRSM buffer, the boot sequence continues at 316.

FIG. 4 illustrates an example RRSM runtime handler method. The method 400 begins at 404. At 408, in determining how register operations are to be handled, the handler determines whether the processor unit is in an “arm” state. As stated above, a processor unit could be in an “arm” state during a computing device startup sequence or at any time after the startup sequence through an out-of-band channel. If the processor unit is not in an arm state, the register operation operates on a hardware register at 412 (and operates as a register operation 104 belonging to the “normal” operating mode (e.g., register operations 110 and 116 of FIGS. 1-2)). If the processor unit is in arm state (416), the handler determines whether the processor unit has transitioned to a trigger state at 420. If not, the handler writes the register operation to the quiesce (RRSM) buffer at 424. If the processor unit has transitioned to a trigger state, the register operations in the quiesce buffer are executed at 428. The handler terminates at 432. In some embodiments of method 400, after execution of the register operations in the RRSM buffer, the method can restart at 404. In some embodiments, the RRSM runtime handler can be implemented as an RRSM runtime handler module.

In some embodiments, the register replay state machine technologies described herein can be implemented through a combined hardware and firmware design. The hardware aspects of the RRSM can include the quiesce buffer (e.g., a register set, dedicated RRSM memory) and accompanying logic implemented in dedicated logic. The firmware aspects of the RRSM can comprise the RRSM runtime handler. In some embodiments, the RRSM hardware can execute the read, write, and read-modify-write register operations stored in the quiesce buffer without the involvement of processor unit execution logic (e.g., execution logic 750 of FIG. 67). In other embodiments, the register operations stored in a quiesce buffer can be executed by processor unit execution logic (e.g., execution logic 750). Thus, in such embodiments, the RRSM logic can send the information indicating register operations stored in the quiesce buffer to other portions of the processor unit (e.g., decoder, execution logic) to be executed by those other portions. The RRSM logic can send the information representing register operations as stored in the quiesce buffer or translate the information representing a register operation into a format that can be processed by the other portions of the processor unit.

In some embodiments, executing the register operations in the quiesce buffer can comprise executing register operations that are stored in system memory (or any other memory other than the quiesce buffer). In some embodiments, the quiesce buffer can store a starting memory address at which information indicating register operations are located and information indicating that the quiesce buffer is to cause register operations stored in system memory (rather than in the quiesce buffer) to be executed. The quiesce buffer can further store information indicating an ending memory address at which the last register operation is stored or continue to cause register operations to be executed until it accesses information indicating that no further register operations are to be caused to be performed. Such embodiments can allow for the straightforward modification of values written to registers as compared to existing approaches. For example, modification of the data being written to a register in a register write operation may necessitate rebuilding a BIOS, but in embodiments where an RRSM buffer performs register operations stored in system memory, the register operations and values written to registers can be updated by updating the information stored at the appropriate locations in system memory.

In another use case, the values written to registers can be determined via an algorithmic approach (such as determining optimal values for programming circuitry implementing the physical layer functions (a PHY) in a network interface controller) in a previous computing system startup sequence and subsequent startup sequences, the RRSM buffer can comprise register write operations that write values determined from the previous startup sequence. By not performing the algorithm approach in determining the values to be written to register, subsequent startup sequences can complete faster.

In some embodiments, the RRSM buffer includes the ability to decrypt encrypted register operations stored in system memory. For example, an RRSM buffer can have a private key to decrypt information encrypted with a microprocessor vendor's public key. This can hamper the ability of third parties to reverse engineer register operations. This can be particularly useful if, for example, the register operations comprise microprocessor vendor trade secrets or confidential information or if the RRSM buffer executes only certain register operations or writes certain register values depending on a characteristic of the computer system or its location on a network (e.g., its IP address).

In some embodiments, the RRSM buffer can be made available to an operating system so that the operating system can program the RRSM buffer. This may allow for RAS that is more operating-system mediated and less platform-managed. In some embodiments, the operating system could interface with an RRSM buffer via an MSR (model-specific register) interface.

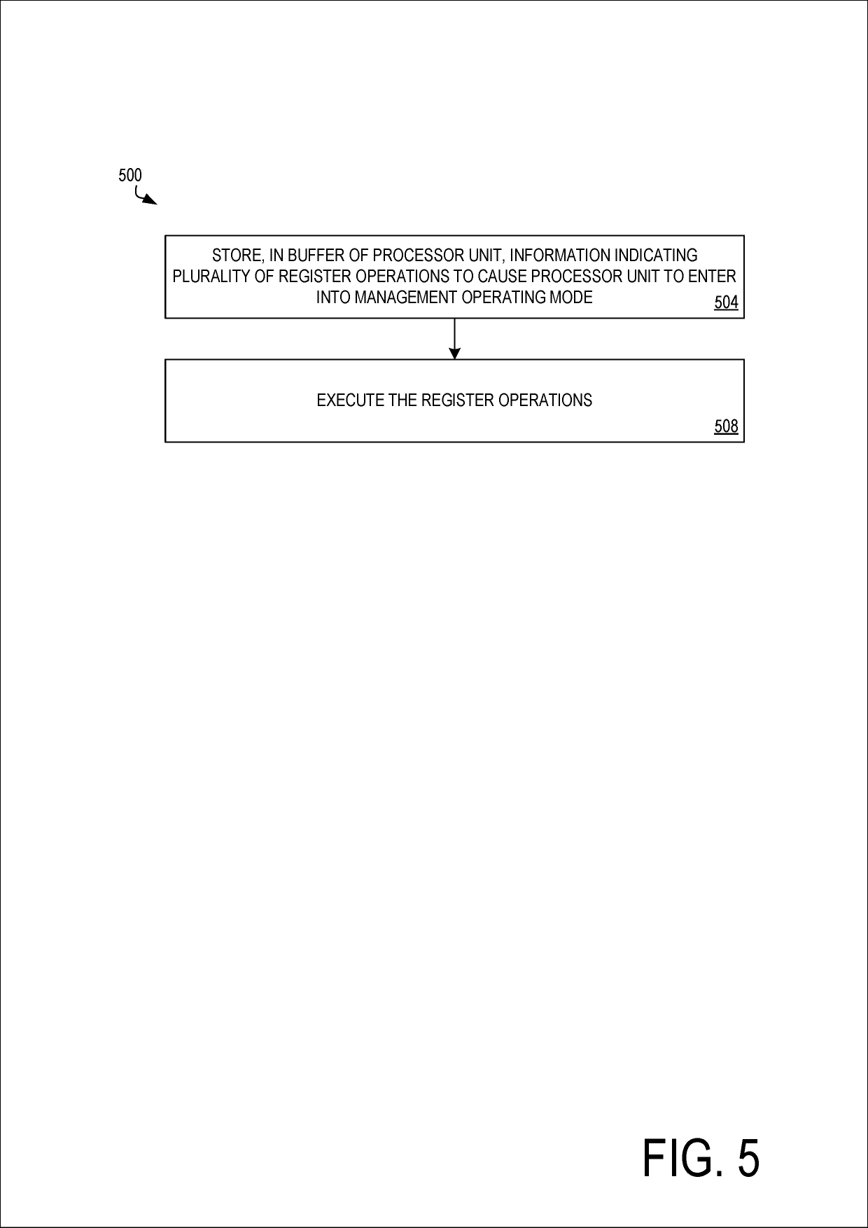

FIG. 5 is an example method of storing register operations to cause a processing unit to enter into a management operating mode in a dedicated buffer and execute the register operations. The method 500 can be performed by, for example, a server computing system. At 504, information indicating a plurality of register operations to cause a processor unit to enter into a management operating mode is stored in a buffer of the processor unit of a computing system. The buffer is dedicated to storing register operations to cause the processor unit to enter into the management operating mode. At 508, the register operations are executed by the processor unit.

In other embodiments, the method 500 can comprise one or more additional elements. For example, the method 500 can further comprise the processor unit executing one or more management operating mode instructions while in the management operating mode. In another example, the method 500 can further comprise receiving, at the processor unit, an interrupt indicating the processor unit is to enter into the management operating mode, wherein the register operations are executed in response to receiving the interrupt at the processor unit.

The technologies described herein can be performed by or implemented in any of a variety of computing systems, including mobile computing systems (e.g., smartphones, handheld computers, tablet computers, laptop computers, portable gaming consoles, 2-in-1 convertible computers, portable all-in-one computers), non-mobile computing systems (e.g., desktop computers, servers, workstations, stationary gaming consoles, set-top boxes, smart televisions, rack-level computing solutions (e.g., blade, tray, or sled computing systems)), and embedded computing systems (e.g., computing systems that are part of a vehicle, smart home appliance, consumer electronics product or equipment, manufacturing equipment). As used herein, the term “computing system” includes computing devices and includes systems comprising multiple discrete physical components. In some embodiments, the computing systems are located in a data center, such as an enterprise data center (e.g., a data center owned and operated by a company and typically located on company premises), managed services data center (e.g., a data center managed by a third party on behalf of a company), a colocated data center (e.g., a data center in which data center infrastructure is provided by the data center host and a company provides and manages their own data center components (servers, etc.)), cloud data center (e.g., a data center operated by a cloud services provider that host companies applications and data), and an edge data center (e.g., a data center, typically having a smaller footprint than other data center types, located close to the geographic area that it serves).

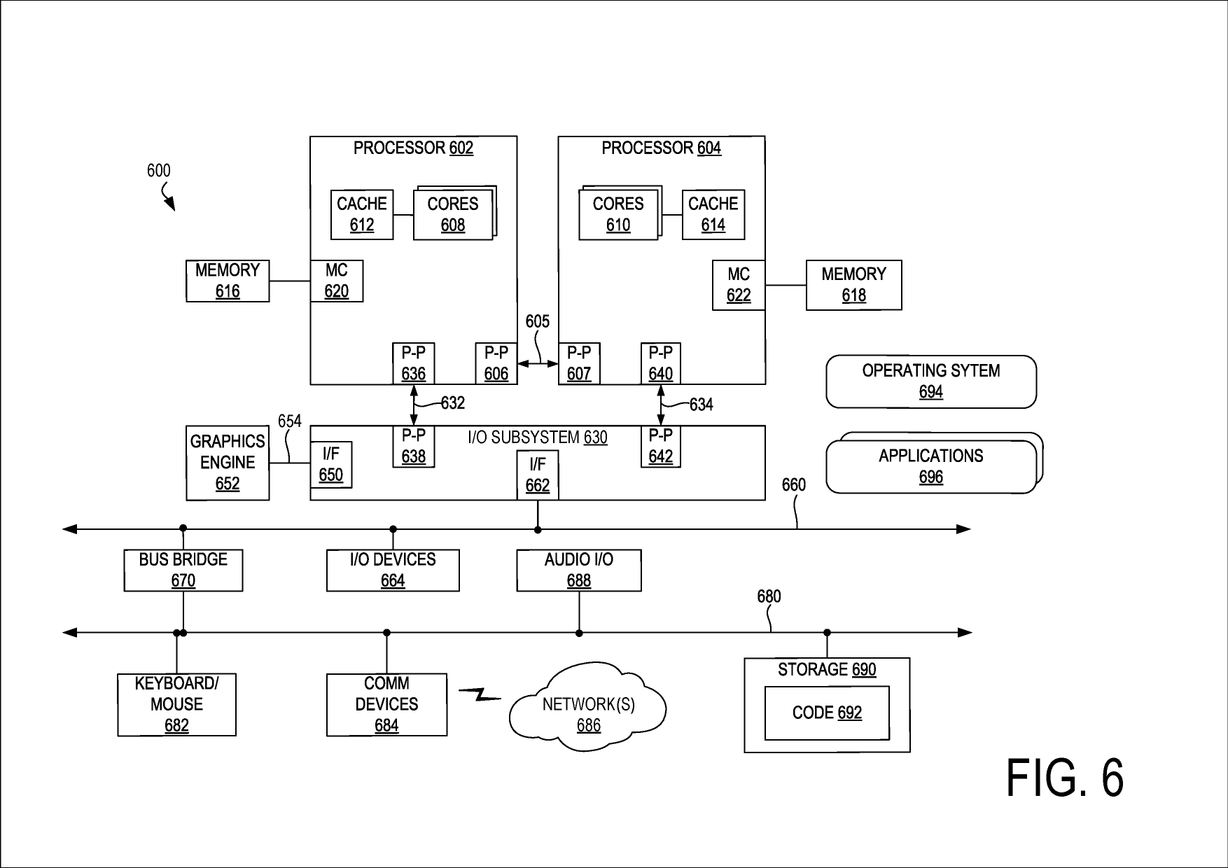

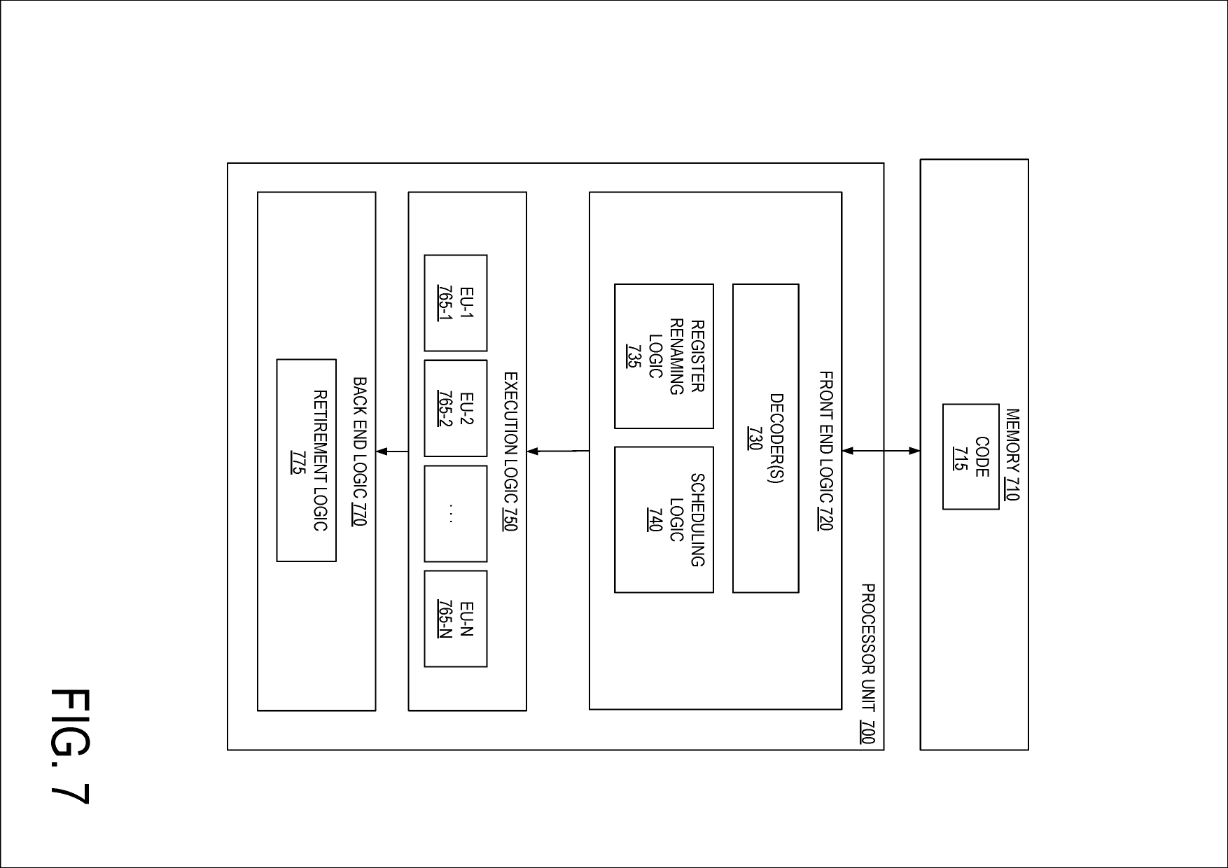

FIG. 6 is a block diagram of a second example computing system in which technologies described herein may be implemented. Generally, components shown in FIG. 6 can communicate with other shown components, although not all connections are shown, for ease of illustration. The computing system 600 is a multiprocessor system comprising a first processor unit 602 and a second processor unit 604 comprising point-to-point (P-P) interconnects. A point-to-point (P-P) interface 606 of the processor unit 602 is coupled to a point-to-point interface 607 of the processor unit 604 via a point-to-point interconnection 605. It is to be understood that any or all of the point-to-point interconnects illustrated in FIG. 6 can be alternatively implemented as a multi-drop bus, and that any or all buses illustrated in FIG. 6 could be replaced by point-to-point interconnects.

The processor units 602 and 604 comprise multiple processor cores. Processor unit 602 comprises processor cores 608 and processor unit 604 comprises processor cores 610. Processor cores 608 and 610 can execute computer-executable instructions in a manner similar to that discussed below in connection with FIG. 7, or other manners.

Processor units 602 and 604 further comprise cache memories 612 and 614, respectively. The cache memories 612 and 614 can store data (e.g., instructions) utilized by one or more components of the processor units 602 and 604, such as the processor cores 608 and 610. The cache memories 612 and 614 can be part of a memory hierarchy for the computing system 600. For example, the cache memories 612 can locally store data that is also stored in a memory 616 to allow for faster access to the data by the processor unit 602. In some embodiments, the cache memories 612 and 614 can comprise multiple cache levels, such as level 1 (L1), level 2 (L2), level 3 (L3), level 4 (L4) and/or other caches or cache levels. In some embodiments, one or more levels of cache memory (e.g., L2, L3, L4) can be shared among multiple cores in a processor unit or among multiple processor units in an integrated circuit component. In some embodiments, the last level of cache memory on an integrated circuit component can be referred to as a last level cache (LLC). One or more of the higher levels of cache levels (the smaller and faster caches) in the memory hierarchy can be located on the same integrated circuit die as a processor core and one or more of the lower cache levels (the larger and slower caches) can be located on an integrated circuit dies that are physically separate from the processor core integrated circuit dies.

Although the computing system 600 is shown with two processor units, the computing system 600 can comprise any number of processor units. Further, a processor unit can comprise any number of processor cores. A processor unit can take various forms such as a central processor unit (CPU), a graphics processor unit (GPU), general-purpose GPU (GPGPU), accelerated processor unit (APU), field-programmable gate array (FPGA), neural network processor unit (NPU), data processor unit (DPU), accelerator (e.g., graphics accelerator, digital signal processor (DSP), compression accelerator, artificial intelligence (AI) accelerator), controller, or other types of processor units. As such, the processor unit can be referred to as an XPU (or xPU). Further, a processor unit can comprise one or more of these various types of processor units. In some embodiments, the computing system comprises one processor unit with multiple cores, and in other embodiments, the computing system comprises a single processor unit with a single core. As used herein, the terms “processor unit” and “processor unit” can refer to any processor, processor core, component, module, engine, circuitry, or any other processing element described or referenced herein.

In some embodiments, the computing system 600 can comprise one or more processor units that are heterogeneous or asymmetric to another processor unit in the computing system. There can be a variety of differences between the processor units in a system in terms of a spectrum of metrics of merit including architectural, microarchitectural, thermal, power consumption characteristics, and the like. These differences can effectively manifest themselves as asymmetry and heterogeneity among the processor units in a system.

The processor units 602 and 604 can be located in a single integrated circuit component (such as a multi-chip package (MCP) or multi-chip module (MCM)) or they can be located in separate integrated circuit components. An integrated circuit component comprising one or more processor units can comprise additional components, such as embedded DRAM, stacked high bandwidth memory (HBM), shared cache memories (e.g., L3, L4, LLC), input/output (I/O) controllers, or memory controllers. Any of the additional components can be located on the same integrated circuit die as a processor unit, or on one or more integrated circuit dies separate from the integrated circuit dies comprising the processor units. In some embodiments, these separate integrated circuit dies can be referred to as “chiplets”. In some embodiments where there is heterogeneity or asymmetry among processor units in a computing system, the heterogeneity or asymmetric can be among processor units located in the same integrated circuit component. In embodiments where an integrated circuit component comprises multiple integrated circuit dies, interconnections between dies can be provided by the package substrate, one or more silicon interposers, one or more silicon bridges embedded in the package substrate (such as Intel® embedded multi-die interconnect bridges (EMIBs)), or combinations thereof.

Processor units 602 and 604 further comprise memory controller logic (MC) 620 and 622. As shown in FIG. 6, MCs 620 and 622 control memories 616 and 618 coupled to the processor units 602 and 604, respectively. The memories 616 and 618 can comprise various types of volatile memory (e.g., dynamic random-access memory (DRAM), static random-access memory (SRAM)) and/or non-volatile memory (e.g., flash memory, chalcogenide-based phase-change non-volatile memories), and comprise one or more layers of the memory hierarchy of the computing system. While MCs 620 and 622 are illustrated as being integrated into the processor units 602 and 604, in alternative embodiments, the MCs can be external to a processor unit.

Processor units 602 and 604 are coupled to an Input/Output (I/O) subsystem 630 via point-to-point interconnections 632 and 634. The point-to-point interconnection 632 connects a point-to-point interface 636 of the processor unit 602 with a point-to-point interface 638 of the I/O subsystem 630, and the point-to-point interconnection 634 connects a point-to-point interface 640 of the processor unit 604 with a point-to-point interface 642 of the I/O subsystem 630. Input/Output subsystem 630 further includes an interface 650 to couple the I/O subsystem 630 to a graphics engine 652. The I/O subsystem 630 and the graphics engine 652 are coupled via a bus 654.

The Input/Output subsystem 630 is further coupled to a first bus 660 via an interface 662. The first bus 660 can be a Peripheral Component Interconnect Express (PCIe) bus or any other type of bus. Various I/O devices 664 can be coupled to the first bus 660. A bus bridge 670 can couple the first bus 660 to a second bus 680. In some embodiments, the second bus 680 can be a low pin count (LPC) bus. Various devices can be coupled to the second bus 680 including, for example, a keyboard/mouse 682, audio I/O devices 688, and a storage device 690, such as a hard disk drive, solid-state drive, or another storage device for storing computer-executable instructions (code) 692 or data. The code 692 can comprise computer-executable instructions for performing methods described herein. Additional components that can be coupled to the second bus 680 include communication device(s) 684, which can provide for communication between the computing system 600 and one or more wired or wireless networks 686 (e.g. Wi-Fi, cellular, or satellite networks) via one or more wired or wireless communication links (e.g., wire, cable, Ethernet connection, radio-frequency (RF) channel, infrared channel, Wi-Fi channel) using one or more communication standards (e.g., IEEE 602.11 standard and its supplements).

In embodiments where the communication devices 684 support wireless communication, the communication devices 684 can comprise wireless communication components coupled to one or more antennas to support communication between the computing system 600 and external devices. The wireless communication components can support various wireless communication protocols and technologies such as Near Field Communication (NFC), IEEE 1002.11 (Wi-Fi) variants, WiMax, Bluetooth, Zigbee, 4G Long Term Evolution (LTE), Code Division Multiplexing Access (CDMA), Universal Mobile Telecommunication System (UMTS) and Global System for Mobile Telecommunication (GSM), and 5G broadband cellular technologies. In addition, the wireless modems can support communication with one or more cellular networks for data and voice communications within a single cellular network, between cellular networks, or between the computing system and a public switched telephone network (PSTN).

The system 600 can comprise removable memory such as flash memory cards (e.g., SD (Secure Digital) cards), memory sticks, Subscriber Identity Module (SIM) cards). The memory in system 600 (including caches 612 and 614, memories 616 and 618, and storage device 690) can store data and/or computer-executable instructions for executing an operating system 694 and application programs 696. Example data includes web pages, text messages, images, sound files, and video data to be sent to and/or received from one or more network servers or other devices by the system 600 via the one or more wired or wireless networks 686, or for use by the system 600. The system 600 can also have access to external memory or storage (not shown) such as external hard drives or cloud-based storage.

The operating system 694 can control the allocation and usage of the components illustrated in FIG. 6 and support the one or more application programs 696. The application programs 696 can include common computing system applications (e.g., email applications, calendars, contact managers, web browsers, messaging applications) as well as other computing applications.

In some embodiments, a hypervisor (or virtual machine manager) operates on the operating system 694 and the application programs 696 operate within one or more virtual machines operating on the hypervisor. In these embodiments, the hypervisor is a type-2 or hosted hypervisor as it is running on the operating system 694. In other hypervisor-based embodiments, the hypervisor is a type-1 or “bare-metal” hypervisor that runs directly on the platform resources of the computing system 694 without an intervening operating system layer.

In some embodiments, the applications 696 can operate within one or more containers. A container is a running instance of a container image, which is a package of binary images for one or more of the applications 696 and any libraries, configuration settings, and any other information that one or more applications 696 need for execution. A container image can conform to any container image format, such as Docker®, Appc, or LXC container image formats. In container-based embodiments, a container runtime engine, such as Docker Engine, LXU, or an open container initiative (OCI)-compatible container runtime (e.g., Railcar, CRI-O) operates on the operating system (or virtual machine monitor) to provide an interface between the containers and the operating system 694. An orchestrator can be responsible for management of the computing system 600 and various container-related tasks such as deploying container images to the computing system 694, monitoring the performance of deployed containers, and monitoring the utilization of the resources of the computing system 694.

The computing system 600 can support various additional input devices, such as a touchscreen, microphone, monoscopic camera, stereoscopic camera, trackball, touchpad, trackpad, proximity sensor, light sensor, and one or more output devices, such as one or more speakers or displays. Other possible input and output devices include piezoelectric and other haptic I/O devices. Any of the input or output devices can be internal to, external to, or removably attachable with the system 600. External input and output devices can communicate with the system 600 via wired or wireless connections.

The system 600 can further include at least one input/output port comprising physical connectors (e.g., USB, IEEE 1394 (FireWire), Ethernet, RS-232), a power supply (e.g., battery), a global satellite navigation system (GNSS) receiver (e.g., GPS receiver); a gyroscope; an accelerometer; and/or a compass. A GNSS receiver can be coupled to a GNSS antenna. The computing system 600 can further comprise one or more additional antennas coupled to one or more additional receivers, transmitters, and/or transceivers to enable additional functions.

In addition to those already discussed, integrated circuit components, integrated circuit constituent components, and other components in the computing system 694 can communicate with interconnect technologies such as Intel® QuickPath Interconnect (QPI), Intel® Ultra Path Interconnect (UPI), Computer Express Link (CXL), cache coherent interconnect for accelerators (CCTV)), serializer/deserializer (SERDES), Nvidia® NVLink, ARM Infinity Link, Gen-Z, or Open Coherent Accelerator Processor Interface (OpenCAPI). Other interconnect technologies may be used and a computing system 694 may utilize more or more interconnect technologies.

It is to be understood that FIG. 6 illustrates only one example computing system architecture. Computing systems based on alternative architectures can be used to implement technologies described herein. For example, instead of the processors 602 and 604 and the graphics engine 652 being located on discrete integrated circuits, a computing system can comprise an SoC (system-on-a-chip) integrated circuit incorporating multiple processors, a graphics engine, and additional components. Further, a computing system can connect its constituent component via bus or point-to-point configurations different from that shown in FIG. 6. Moreover, the illustrated components in FIG. 6 are not required or all-inclusive, as shown components can be removed and other components added in alternative embodiments.

FIG. 7 is a block diagram of an example processor unit 700 to execute computer-executable instructions as part of implementing technologies described herein. The processor unit 700 can be a single-threaded core or a multithreaded core in that it may include more than one hardware thread context (or “logical processor”) per processor unit.

FIG. 7 also illustrates a memory 710 coupled to the processor unit 700. The memory 710 can be any memory described herein or any other memory known to those of skill in the art. The memory 710 can store computer-executable instructions 715 (code) executable by the processor unit 700.

The processor unit comprises front-end logic 720 that receives instructions from the memory 710. An instruction can be processed by one or more decoders 730. The decoder 730 can generate as its output a micro-operation such as a fixed width micro-operation in a predefined format, or generate other instructions, microinstructions, or control signals, which reflect the original code instruction. The front-end logic 720 further comprises register renaming logic 735 and scheduling logic 740, which generally allocate resources and queues operations corresponding to converting an instruction for execution.

The processor unit 700 further comprises execution logic 750, which comprises one or more execution units (EUs) 765-1 through 765-N. Some processor unit embodiments can include a number of execution units dedicated to specific functions or sets of functions. Other embodiments can include only one execution unit or one execution unit that can perform a particular function. The execution logic 750 performs the operations specified by code instructions. After completion of execution of the operations specified by the code instructions, back-end logic 770 retires instructions using retirement logic 775. In some embodiments, the processor unit 700 allows out of order execution but requires in-order retirement of instructions. Retirement logic 775 can take a variety of forms as known to those of skill in the art (e.g., re-order buffers or the like).

The processor unit 700 is transformed during execution of instructions, at least in terms of the output generated by the decoder 730, hardware registers and tables utilized by the register renaming logic 735, and any registers (not shown) modified by the execution logic 750.

As used herein, the term “module” refers to logic that may be implemented in a hardware component or device, software or firmware running on a processor unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processor units, state machine circuitry, and/or firmware that stores instructions executable by programmable circuitry. Modules described herein may, collectively or individually, be embodied as circuitry that forms a part of a computing system. Thus, any of the modules can be implemented as circuitry, such as RRSM runtime handler circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product. Such instructions can cause a computing system or one or more processor units capable of executing computer-executable instructions to perform any of the disclosed methods. As used herein, the term “computer” refers to any computing system, device, or machine described or mentioned herein as well as any other computing system, device, or machine capable of executing instructions. Thus, the term “computer-executable instruction” refers to instructions that can be executed by any computing system, device, or machine described or mentioned herein as well as any other computing system, device, or machine capable of executing instructions.

The computer-executable instructions or computer program products as well as any data created and/or used during implementation of the disclosed technologies can be stored on one or more tangible or non-transitory computer-readable storage media, such as volatile memory (e.g., DRAM, SRAM), non-volatile memory (e.g., flash memory, chalcogenide-based phase-change non-volatile memory) optical media discs (e.g., DVDs, CDs), and magnetic storage (e.g., magnetic tape storage, hard disk drives). Computer-readable storage media can be contained in computer-readable storage devices such as solid-state drives, USB flash drives, and memory modules. Alternatively, any of the methods disclosed herein (or a portion) thereof may be performed by hardware components comprising non-programmable circuitry. In some embodiments, any of the methods herein can be performed by a combination of non-programmable hardware components and one or more processor units executing computer-executable instructions stored on computer-readable storage media.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C#, Java, Perl, Python, JavaScript, Adobe Flash, C#, assembly language, or any other programming language. Likewise, the disclosed technologies are not limited to any particular computer system or type of hardware.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

As used in this application and the claims, a list of items joined by the term “and/or” can mean any combination of the listed items. For example, the phrase “A, B and/or C” can mean A; B; C; A and B; A and C; B and C; or A, B and C. As used in this application and the claims, a list of items joined by the term “at least one of” can mean any combination of the listed terms. For example, the phrase “at least one of A, B or C” can mean A; B; C; A and B; A and C; B and C; or A, B, and C. Moreover, as used in this application and the claims, a list of items joined by the term “one or more of” can mean any combination of the listed terms. For example, the phrase “one or more of A, B and C” can mean A; B; C; A and B; A and C; B and C; or A, B, and C.

As used in this application and the claims, the phrase “individual of” or “respective of” following by a list of items recited or stated as having a trait, feature, etc. means that all of the items in the list possess the stated or recited trait, feature, etc. For example, the phrase “individual of A, B, or C, comprise a sidewall” or “respective of A, B, or C, comprise a sidewall” means that A comprises a sidewall, B comprises sidewall, and C comprises a sidewall.

The disclosed methods, apparatuses, and systems are not to be construed as limiting in any way. Instead, the present disclosure is directed toward all novel and nonobvious features and aspects of the various disclosed embodiments, alone and in various combinations and subcombinations with one another. The disclosed methods, apparatuses, and systems are not limited to any specific aspect or feature or combination thereof, nor do the disclosed embodiments require that any one or more specific advantages be present or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

Although the operations of some of the disclosed methods are described in a particular, sequential order for convenient presentation, it is to be understood that this manner of description encompasses rearrangement, unless a particular ordering is required by specific language set forth herein. For example, operations described sequentially may in some cases be rearranged or performed concurrently. Moreover, for the sake of simplicity, the attached figures may not show the various ways in which the disclosed methods can be used in conjunction with other methods.

The following examples pertain to additional embodiments of technologies disclosed herein.

Example 1 includes a method comprising storing, in a buffer of a processor unit, information indicating a plurality of register operations to cause the processor unit to enter into a management operating mode, the processor unit located in a computing system; receiving, at the processor unit, information indicating that the processor unit is to enter the management operating mode; and executing, by the processor unit, the register operations in response to receiving the information indicating that the processor unit is to enter the management operating mode.

Example 2 includes the subject matter of Example 1, and further including the processor unit executing one or more management operating mode instructions while in the management operating mode.

Example 3 includes the subject matter of Example 1 or 2, wherein the processor unit is a first processor unit, the buffer is a first buffer, the computing system comprises one or more second processor units, individual of the second processor units comprises a second buffer, the method further comprising, for individual of the second processor units storing, in the second buffer of the individual second processor unit, the information indicating the register operations; and executing, by the individual second processor unit the register operations.

Example 4 includes the subject matter of Example 3, the register operations to cause the second processor units to enter into an idle state.

Example 5 includes the subject matter of Example 1, the register operations to cause the processor unit to store a state of the processor unit.

Example 6 includes the subject matter of Example 5, the register operations to further cause the processor unit to exit the management operating mode.

Example 7 includes the subject matter of Example 6, and wherein the register operations to cause the processor unit to exit the management operating mode cause the processor unit to restore the state of the processor unit.

Example 8 includes the subject matter of any one of Examples 1-2 and 5-7, wherein the information indicating that the processor unit is to enter the management operating mode comprises an interrupt, wherein the information indicating the plurality of register operations to cause the processor unit to enter into the management operating mode are stored in the buffer prior to receiving the interrupt at the processor unit and the register operations are executed in response to receiving the interrupt at the processor unit.

Example 9 includes the subject matter of any one of Examples 1-8, wherein storing the information indicating the register operations is performed during a startup sequence of the computing system.

Example 10 includes the subject matter of any one of Examples 1-8, wherein storing the information indicating the register operations is performed by a host BIOS (built-in input/output system).

Example 11 includes the subject matter of any one of Examples 1-8, wherein storing the information indicating the register operations is performed by an out-of-band facing manageability agent.

Example 12 includes the subject matter of any one of Examples 1-8, wherein storing the information indicating register operations is performed out-of-band after completion of a startup sequence of the computing system.

Example 13 includes the subject matter of any one of Examples 1-12, wherein the information indicating the plurality of register operations comprises information indicating a register operation is stored in system memory and information indicating a system memory address at which the register operation stored in system memory is stored.

Example 14 includes the subject matter of Example 13, and wherein the register operation stored in system memory is encrypted, the method further comprises decrypting the register operation stored in system memory.

Example 15 includes the subject matter of any one of Examples 1-14, wherein the buffer is dedicated for storing management operation mode register operations.

Example 16 includes a computing system comprising a processor unit; and one or more computer-readable storage media storing computer-executable instructions that, when executed, cause the processor units to store, in a buffer of the processor unit, information indicating a plurality of register operations to cause the processor unit to enter into a management operating mode; receive, at the processor unit, information indicating that the processor unit is to enter the management operating mode; and execute, by the processor unit, the register operations in response to receiving the information indicating that the processor unit is to enter the management operating mode.

Example 17 includes the subject matter of Example 16, the instructions to further cause the processor unit to execute one or more management operating mode instructions while in the management operating mode.

Example 18 includes the subject matter of Example 16 or 17, wherein the processor unit is a first processor unit, the buffer is a first buffer, the computing system comprises one or more second processor units, individual of the second processor units comprises a second buffer, the instructions, when executed, by individual of the second processor units, cause the individual second processor units to store, in the second buffer of the individual second processor unit, the information indicating the register operations; and execute the register operations.

Example 19 includes the subject matter of Example 18, the register operations to cause the second processor units to enter into an idle state.

Example 20 includes the subject matter of Example 16, the register operations to cause the processor unit to store a state of the processor unit.

Example 21 includes the subject matter of Example 16 or 20, the register operations to further cause the processor unit to exit the management operating mode.

Example 22 includes the subject matter of any of Example 21, and wherein the register operations to cause the processor unit to exit the management operating mode cause the processor unit to restore the state of the processor unit.

Example 23 includes the subject matter of any one of Examples 16-17 and 20-22, wherein the information indicating that the processor unit is to enter the management operating mode comprises an interrupt indicating the processor unit is to enter the management operating mode and the information indicating the plurality of register operations to cause the processor unit to enter into the management operating mode are stored in the buffer prior to the processor unit receiving the interrupt.

Example 24 includes the subject matter of any one of Examples 16-23, wherein the instructions are to cause the processor unit to store the information indicating the register operations during a startup sequence of the computing system.

Example 25 includes the subject matter of any one of Examples 16-23, wherein the instructions to cause the processor unit to store the information indicating the register operations are part of a host BIOS (built-in input/output system).

Example 26 includes the subject matter of any one of Examples 16-23, wherein the instructions to cause the processor unit to store the information indicating the register operations are part of an out-of-band facing manageability agent.

Example 27 includes the subject matter of any one of Examples 16-23, wherein the instructions to cause the processor unit to store the information indicating register operations are performed out-of-band after completion of a startup sequence of the computing system.

Example 28 includes the subject matter of any one of Examples 16-27, wherein the information indicating the plurality of register operations comprises information indicating a register operation is stored in system memory and information indicating a system memory address at which the register operation stored in system memory is stored.

Example 29 includes the subject matter of any of Example 28, and wherein the register operation stored in system memory is encrypted, the instructions to further cause the processing unit to decrypt the register operation stored in system memory.

Example 30 includes the subject matter of any one of Examples 16-29, wherein the buffer is dedicated for storing management operation mode register operations.

Example 31 includes one or more computer-readable storage media storing computer-executable instructions that, when executed, cause a processor unit of a computing system to store, in a buffer of the processor unit, information indicating a plurality of register operations to cause the processor unit to enter into a management operating mode, the processor unit located in the computing system, the buffer dedicated for storing register operations to cause the processor unit to enter into the management operating mode; receive, at the processor unit, information indicating that the processor unit is to enter the management operating mode; and execute the register operations in response to receiving the information indicating that the processor unit is to enter the management operating mode.

Example 32 includes the subject matter of Example 31, the instructions to further cause the processor unit to execute one or more management operating mode instructions while in the management operating mode.

Example 33 includes the subject matter of Example 31 or 32, wherein the processor unit is a first processor unit, the buffer is a first buffer, the computing system comprises one or more second processor units, individual of the second processor units comprises a second, the instructions, when executed by the computing system, to further cause individual of the second processor units to store, in the second buffer of the individual second processor unit, the information indicating the register operations; and execute the register operations.

Example 34 includes the subject matter of Example 33, the register operations to cause the second processor units to enter into an idle state.

Example 35 includes the subject matter of Example 31, the register operations to cause the processor unit to store a state of the processor unit.

Example 36 includes the subject matter of Example 35, the register operations to further cause the processor unit to exit the management operating mode.

Example 37 includes the subject matter of any of Example 36, and wherein the register operations to cause the processor unit to exit the management operating mode to cause the processor unit to restore the state of the processor unit.

Example 38 includes the subject matter of any one of Examples 31-32 and 35-36, wherein the information indicating that the processor unit is to enter the management operating mode comprises an interrupt indicating the processor unit is to enter the management operating mode and the information indicating the plurality of register operations to cause the processor unit to enter into the management operating mode are stored in the buffer prior to the processor unit receiving the interrupt.

Example 39 includes the subject matter of any one of Examples 31-38, wherein the instructions are to cause the processor unit to store the information indicating the register operations in the buffer during a startup sequence of the computing system.

Example 40 includes the subject matter of any one of Examples 31-38, wherein the instructions to cause the processor unit to store the information indicating the register operations are part of a host BIOS (built-in input/output system).

Example 41 includes the subject matter of any one of Examples 31-38, wherein the instructions to cause the processor unit to store the information indicating the register operations are part of an out-of-band facing manageability agent.

Example 42 includes the subject matter of any one of Examples 31-38, wherein the instructions to cause the processor unit to store the information indicating register operations are performed out-of-band after completion of a startup sequence of the computing system.

Example 43 includes the subject matter of Example 31-42, wherein the information indicating the plurality of register operations comprises information indicating a register operation is stored in system memory and information indicating a system memory address at which the register operation stored in system memory is stored.

Example 44 includes the subject matter of any of Example 43, and wherein the register operation stored in system memory is encrypted, the instructions to further cause the processing unit to decrypt the register operation stored in system memory.

Example 45 includes the subject matter of Example claims 31-44, wherein the buffer is dedicated for storing management operation mode register operations.

1. A method comprising:
storing, in a buffer of a processor unit, information indicating a plurality of register operations to cause the processor unit to enter into a management operating mode, the processor unit located in a computing system; and
receiving, at the processor unit, information indicating that the processor unit is to enter the management operating mode; and
executing, by the processor unit, the register operations in response to receiving the information indicating that the processor unit is to enter the management operating mode.

2. The method of claim 1, further comprising the processor unit executing one or more management operating mode instructions while in the management operating mode.

3. The method of claim 1, wherein the processor unit is a first processor unit, the buffer is a first buffer, the computing system comprises one or more second processor units, individual of the second processor units comprises a second buffer, the method further comprising, for individual of the second processor units:
storing, in the second buffer of the individual second processor unit, the information indicating the register operations; and
executing, by the individual second processor unit the register operations.

4. The method of claim 3, the register operations to cause the second processor units to enter into an idle state.

5. The method of claim 1, the register operations to cause the processor unit to store a state of the processor unit.

6. The method of claim 5, the register operations to further cause the processor unit to exit the management operating mode, the register operations to cause the processor unit to exit the management operating mode cause the processor unit to restore the state of the processor unit.

7. The method of claim 1, wherein the information indicating that the processor unit is to enter the management operating mode comprises an interrupt, wherein the information indicating the plurality of register operations to cause the processor unit to enter into the management operating mode are stored in the buffer prior to receiving the interrupt at the processor unit and the register operations are executed in response to receiving the interrupt at the processor unit.

8. The method of claim 1, wherein storing the information indicating the register operations is performed during a startup sequence of the computing system.

9. The method of claim 1, wherein storing the information indicating register operations is performed out-of-band after completion of a startup sequence of the computing system.

10. The method of claim 1, wherein the buffer is dedicated for storing management operation mode register operations.

11. A computing system comprising:
a processor unit; and
one or more computer-readable storage media storing computer-executable instructions that, when executed, cause the processor units to:
store, in a buffer of the processor unit, information indicating a plurality of register operations to cause the processor unit to enter into a management operating mode; and
receive, at the processor unit, information indicating that the processor unit is to enter the management operating mode; and
execute, by the processor unit, the register operations in response to receiving the information indicating that the processor unit is to enter the management operating mode.

12. The computing system of claim 11, the instructions to further cause the processor unit to execute one or more management operating mode instructions while in the management operating mode.

13. The computing system of claim 11, wherein the processor unit is a first processor unit, the buffer is a first buffer, the computing system comprises one or more second processor units, individual of the second processor units comprises a second buffer, the instructions, when executed, by individual of the second processor units, cause the individual second processor units to:
store, in the second buffer of the individual second processor unit, the information indicating the register operations; and
execute the register operations.

14. The computing system of claim 13, the register operations to cause the second processor units to enter into an idle state.

15. The computing system of claim 11, wherein the instructions are to cause the processor unit to store the information indicating the register operations during a startup sequence of the computing system.

16. One or more computer-readable storage media storing computer-executable instructions that, when executed, cause a processor unit of a computing system to:
store, in a buffer of the processor unit, information indicating a plurality of register operations to cause the processor unit to enter into a management operating mode, the processor unit located in the computing system, the buffer dedicated for storing register operations to cause the processor unit to enter into the management operating mode; and
receive, at the processor unit, information indicating that the processor unit is to enter the management operating mode; and
execute the register operations in response to receiving the information indicating that the processor unit is to enter the management operating mode.

17. The one or more computer-readable storage media of claim 16, the instructions to further cause the processor unit to execute one or more management operating mode instructions while in the management operating mode.

18. The one or more computer-readable storage media of claim 16, wherein the processor unit is a first processor unit, the buffer is a first buffer, the computing system comprises one or more second processor units, individual of the second processor units comprises a second, the instructions, when executed by the computing system, to further cause individual of the second processor units to:
store, in the second buffer of the individual second processor unit, the information indicating the register operations; and
execute the register operations.

19. The one or more computer-readable storage media of claim 18, the register operations to cause the second processor units to enter into an idle state.

20. The one or more computer-readable storage media of claim 16, wherein the instructions are to cause the processor unit to store the information indicating the register operations in the buffer during a startup sequence of the computing system.
